(19) United States
(12) Patent Application Publication
(10) Pub. No.: US 2025/0315571 A1
(43) Pub. Date: Oct. 9, 2025

(54) SYSTEM AND METHOD FOR NEURAL NETWORK ACCELERATOR AND TOOLCHAIN DESIGN AUTOMATION

(71) Applicants: AI Chip Center for Emerging Smart Systems Limited, Hong Kong (CN); The Hong Kong University of Science and Technology, Hong Kong (CN)

(72) Inventors: Yu LIU, Hong Kong (CN); Di PANG, Hong Kong (CN); Kwang-Ting CHENG, Hong Kong (CN); Yuhao DING, Hong Kong (CN); Man To YUNG, Hong Kong (CN); Luhong LIANG, Hong Kong (CN); Chi Ying TSUI, Hong Kong (CN); Xuejiao LIU, Hong Kong (CN); Peng LUO, Hong Kong (CN)

(21) Appl. No.: 19/090,397

(22) Filed: Mar. 26, 2025

Related U.S. Application Data
(60) Provisional application No. 63/631,461, filed on Apr. 9, 2024.

(51) Int. Cl. G06F 30/20; G06F 8/36; G06F 11/3668; G06F 111/04; G06F 119/06; G06F 119/12

(52) U.S. Cl. CPC G06F 30/20; G06F 8/36; G06F 11/3696; G06F 2111/04; G06F 2119/06; G06F 2119/12

(57) ABSTRACT

A system and method is provided for designing and optimizing hardware accelerators for neural networks. During a pre-design phase, rules are extracted from compilation patterns that describe conversion between neural network operators, coarse-grained operators, and fine-grained dataflow. A fast mapper for converting neural network models to coarse-grained operator descriptions and a dataflow mapper are generated. A coarse-grained design phase employs an architecture optimizer to generate plural provisional hardware accelerator designs The coarse-grained operator descriptions are simulated using a coarse-grained simulator to obtain performance metrics of each provisional accelerator design. A fine-grained design phase employs a dataflow mapper and fine-grained simulator to finalize provisional hardware accelerator designs. A hardware accelerator is generated from a finalized hardware accelerator design and a corresponding software toolchain is created including a compiler and software development kit (SDK) for programming, debugging, and deploying the hardware accelerator design.

### CROSS-REFERENCE TO RELEVANT APPLICATIONS

The present application claims priority from a U.S. provisional patent application Ser. No. 63/631,461 filed Apr. 9, 2024, and the disclosure of which is incorporated herein by reference.

### FIELD OF THE INVENTION

The present invention generally relates to the field of neural network accelerators. More specifically, the present invention relates to an automated multi-granularity system for design and generation of neural network accelerators and toolchains, and a method of using the system to design and generate customizable neural network accelerators and toolchains thereof.

### BACKGROUND OF THE INVENTION

Machine learning has become a cornerstone of modern technology, driving advancements in fields such as computer vision, natural language processing, and autonomous systems. Machine learning refers to a broad class of computational techniques that enable systems to learn patterns and make decisions or predictions based on data. Neural networks, a subset of machine learning algorithms, are modeled after the structure and function of biological neural networks. These algorithms are particularly well-suited for solving complex tasks such as image recognition, natural language processing, and autonomous control systems.

In recent years, neural networks have become the foundation of deep learning, an advanced branch of machine learning that employs multilayered architectures to process large datasets and perform highly complex computations. As the complexity of neural network architectures has grown, including models like convolutional neural networks (CNNs) and Transformers, their computational demands have increased dramatically. This has necessitated the development of specialized hardware accelerators to efficiently implement and scale these machine learning models.

These specialized hardware accelerators are configured to meet performance, energy, and latency constraints of the network in which they operate. Hardware accelerators may be designed to optimize tasks such as matrix multiplication and convolution, enabling real-time inference and efficient model training.

However, the process of designing optimal hardware accelerators for machine learning applications remains a significant challenge due to several inherent limitations in the current environment:

Complexity of Design Space: The design of hardware accelerators involves navigating an enormous design space, where various parameters—such as computer engine configurations, memory hierarchies, and dataflow architectures—must be optimized to meet application-specific constraints. Exploring this design space efficiently is a highly complex task, often requiring multiple iterations of design, testing, and refinement.

Manual Design Effort: Traditional hardware accelerator design processes rely heavily on manual effort, requiring domain experts to evaluate trade-offs between performance, power consumption, and area constraints. This manual approach is not only time-consuming but also prone to errors, particularly as neural network models evolve rapidly with increasingly diverse architectures and operations.

Lack of Extensibility: Existing methods often target specific types of neural network architectures, such as convolutional neural networks (CNNs), and are difficult to extend to newer, more complex models, such as Transformers. As a result, significant effort is required to adapt hardware designs and software toolchains to support these emerging architectures.

Fragmented Development Process: The development of hardware accelerators and their corresponding software toolchains is typically fragmented, with little automation to integrate the two. Designing an accelerator requires not only optimizing hardware configurations but also creating a specialized toolchain to support model compilation, debugging, and deployment. This lack of integration increases development time and hinders efficiency.

Inefficient Trade-Off Management: Balancing multiple design objectives—such as latency, throughput, power efficiency, and chip area—requires a systematic approach. Existing methods often focus on single-objective optimization or rely on ad hoc techniques, which fail to capture the trade-offs necessary to produce Pareto-optimal designs.

Time and Cost Constraints: The time and computational cost associated with conventional design and optimization processes are significant. For example, traditional design space exploration methods may take weeks or even months to finalize a single accelerator design, making them impractical for industries where time-to-market is critical.

As a result of these challenges, there is an urgent need for an automated system that can efficiently design hardware accelerators and generate corresponding toolchains while minimizing manual intervention. Such a system would reduce development time, improve design quality, and enable the rapid adoption of new neural network architectures across a wide range of applications. The present invention addresses this need.

### SUMMARY OF THE INVENTION

A system and method is provided for designing and optimizing hardware accelerators and toolchains for machine learning that includes neural networks. During a pre-design phase rules are extracted from compilation patterns that describe conversion between neural network operators, coarse-grained operators, and fine-grained dataflow. The pre-design phase generates a fast mapper for converting neural network models to coarse-grained operator descriptions and a dataflow mapper converting the coarse-grained operator descriptions to fine-grained dataflow, loop optimization rules, and memory optimization rules. A toolchain builder is also generated.

A coarse-grained design phase employs an architecture optimizer to interact with the fast mapper to generate plural provisional hardware accelerator designs balancing one or more of power consumption optimization, latency optimization, chip area, and throughput. The coarse-grained operator descriptions are simulated on each provisional accelerator design using a coarse-grained simulator to obtain performance metrics of each provisional accelerator design.

A fine-grained design phase employs a dataflow mapper and fine-grained simulator to form a selected hardware accelerator design from the plural provisional accelerator designs and create fine-grained dataflow descriptions based on compilation rules and conducted optimizations.

In a generation phase, a hardware accelerator is generated from the selected hardware accelerator design and a corresponding software toolchain is created for the selected hardware accelerator design. The software toolchain including a compiler and software development kit (SDK) for programming, debugging, and deploying the selected hardware accelerator design. Plural hardware accelerator/software toolchain pairs may optionally be created by the system, each one being Pareto-optimal.

### BRIEF DESCRIPTIONS OF DRAWINGS

Embodiments of the invention are described in more details hereinafter with reference to the drawings, in which:

FIG. 1 shows a block diagram illustrating the system of the present invention that automates the design process of hardware accelerators and toolchains for the accelerators;

FIG. 2 shows a flowchart depicting the process in the compiler;

FIG. 3 shows a flowchart depicting the process of fast mapper;

FIG. 4 shows a flowchart depicting the process of an exemplary architecture optimizer;

FIG. 5 shows a flowchart depicting the process of dataflow mapper;

FIG. 6 shows a flowchart depicting the process of dataflow optimizer;

FIG. 7 shows a block diagram illustrating an exemplary accelerator architecture;

FIG. 8 shows a block diagram illustrating an exemplary Tensor Data Processor hardware module;

FIG. 9 shows a block diagram of an exemplary Special Processing Unit hardware module;

FIG. 10 shows the evaluation results of fast mapper and dataflow mapper of the present invention;

FIG. 11 shows the comparison between the performances of the coarse-grained simulator of the present invention and conventional EDA simulator;

FIG. 12 shows the comparison of time required to complete an end-to-end design optimization between the system of the present invention and convention DSE flow; and

FIG. 13 shows the comparison of performances among different accelerator designs sampled in the system of the present invention, organized in a radar chart.

### DEFINITIONS

The present invention is described, in part, using the following technical terms:

### Neural Network

A neural network is a type of machine learning algorithm inspired by the structure and functioning of biological neural networks in the human brain. It is composed of interconnected layers of nodes (or “neurons”), where each node performs a mathematical operation on input data and passes the result to subsequent layers.

Neural networks are used to model complex relationships in data by learning patterns and features from large datasets. Without limitation, the neural networks may comprise one or more convolutional neural networks, deconvolutional neural networks, recurrent neural networks, feed-forward neural networks, generative adversarial networks, Transformer-based architecture, Mamba-based state space models, and mixture of experts (MoE) architecture. The neural networks are typically organized into three types of layers:

Input layer, which receives raw data (e.g., images, text, or numerical data).

Hidden layers, which process the data through weighted connections and activation functions to extract features.

Output layer, which produces predictions or classifications based on the processed data. Neural networks are versatile and can be applied to tasks like image recognition, speech processing, and time-series prediction. They form the foundation of deep learning models, which employ many hidden layers to capture highly complex patterns.

### Convolutional Neural Network (CNN)

A convolutional neural network (CNN) is a specialized type of neural network designed for processing grid-like data, such as images or videos. It uses a mathematical operation called convolution to extract local features from the input data, making it particularly effective for tasks involving spatial or temporal patterns. Key components of a CNN include:

Convolutional layers: These apply filters (kernels) to the input data to detect features such as edges, textures, or shapes.

Pooling layers: These reduce the spatial dimensions of the data, making the network more efficient while preserving important features.

Fully connected layers: These aggregate the extracted features to make predictions or classifications.

CNNs are widely used in computer vision tasks, including object detection, image segmentation, and facial recognition. Their ability to automatically learn hierarchical feature representations has made them a dominant architecture for image-related machine learning problems.

### Transformers (for Machine Learning)

A Transformer is a neural network architecture designed for processing sequential data, such as text, audio, or time-series data. It was introduced in 2017 by researchers at Google in the paper “Attention is All You Need.” Unlike traditional recurrent neural networks (RNNs), Transformers use a mechanism called self-attention to process all elements of a sequence simultaneously, rather than one at a time. Key features of Transformers include:

Self-attention mechanism: This allows the model to focus on relevant parts of the input sequence when making predictions, regardless of their position in the sequence.

Positional encoding: Since Transformers process entire sequences in parallel, positional encodings are used to retain information about the order of elements in the sequence.

Scalability: Transformers are highly scalable and have become the foundation of large language models (e.g., GPT, BERT).

The hardware accelerators created by the present invention may be used to implement one or more of the machine learning techniques described above as well as other machine learning workloads.

### Detailed Description

The present invention provides a system and methods for automatically generating pareto-optimal hardware accelerators for executing neural networks and for generating corresponding toolchains for the hardware accelerators.

As used herein, the term “hardware accelerator” describes a specialized computing device or system designed to enhance the performance and efficiency of machine learning tasks by executing specific operations, such as matrix multiplications, convolutions, and activation functions, faster and more energy-efficiently than general-purpose processors.

In general, hardware accelerators may be composed of configurable components, such as computation engines, memory interfaces, internal memory blocks, and controllers, which optimize computational throughput, reduce latency, and minimize energy consumption for running machine learning workloads. In the present invention, hardware accelerators may be implemented as:

Application-Specific Integrated Circuits (ASICs): Custom chips designed for specific tasks, providing maximum efficiency.

Field-Programmable Gate Arrays (FPGAs): Reprogrammable hardware that can adapt to evolving machine learning models.

Neural Processing Units (NPUs): Integrated components within larger processors designed specifically for deep learning tasks.

The hardware accelerators may be incorporated into a variety of computing systems and devices, including but not limited to:

### Data Center Servers

Deployed in cloud or enterprise servers for large-scale machine learning training and inference tasks, such as those supporting artificial intelligence applications like language models, recommendation systems, and search engines.

### Edge Computing Devices

Integrated into edge devices that require low latency and high efficiency, such as Internet of Things (IoT) devices, autonomous vehicles, drones, and smart appliances.

### Personal Computing Devices

Embedded in consumer-grade systems, such as smartphones, laptops, and tablets, to enable real-time AI applications like facial recognition, augmented reality, and natural language processing.

### Embedded Systems

Incorporated into specialized devices, such as industrial automation controllers, medical imaging equipment, and robotics platforms, where real-time inference and power efficiency are critical.

### Autonomous Systems

Integrated into platforms like self-driving cars, drones, and robotic systems to handle compute-intensive tasks like sensor data processing, path planning, and object recognition in real-time.

In the context of hardware accelerator design, “pareto-optimal” refers to a state in which a design cannot be improved in one objective (e.g., latency, power consumption, or chip area) without negatively affecting at least one other objective. It is a key concept in multi-objective optimization, where the goal is to balance competing factors to identify the best possible trade-offs.

A pareto-optimal design is one that lies on the Pareto Front, which represents the set of designs that are considered optimal because they dominate all other possible designs. A design “dominates” another if it is at least as good in all objectives and strictly better in at least one objective. Designs that are not pareto-optimal can be improved in at least one objective without sacrificing performance in others.

For hardware accelerators, the objectives typically include:

Latency: Time required to process a neural network operation.

Power Consumption: Energy required during operation, critical for mobile and edge devices.

Chip Area: Physical semiconductor area used by the accelerator, which affects manufacturing cost.

Throughput: Number of operations the accelerator can perform in a given time period.

Cost: The expense of fabricating and deploying the accelerator.

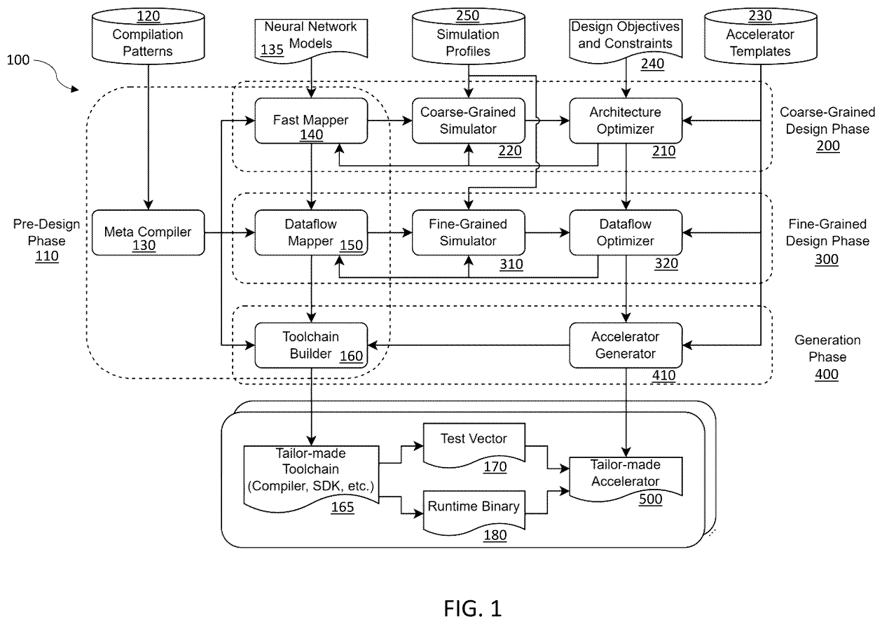

Turning to the drawings in detail, FIG. 1, depicts a system and method 100 for designing and optimizing hardware accelerators and toolchains for machine learning. In the pre-design phase of the hardware accelerator, a meta compiler 110 extracts rules from compilation patterns 120. Compilation patterns 120 describe the conversion between neural network (or other machine learning) operators, coarse-grained operators, and fine-grained dataflow. For example, compilation patterns may convert complex, high-level operations (e.g., matrix multiplications, convolutions) into sequences of hardware-executable instructions or intermediate representations. They ensure that the translation aligns with the hardware's capabilities, such as memory hierarchy, parallelism, and compute engine configurations. Further, compilation patterns can guide design decisions by providing inputs to tools like mappers, simulators, and optimizers during the hardware design and refinement process.

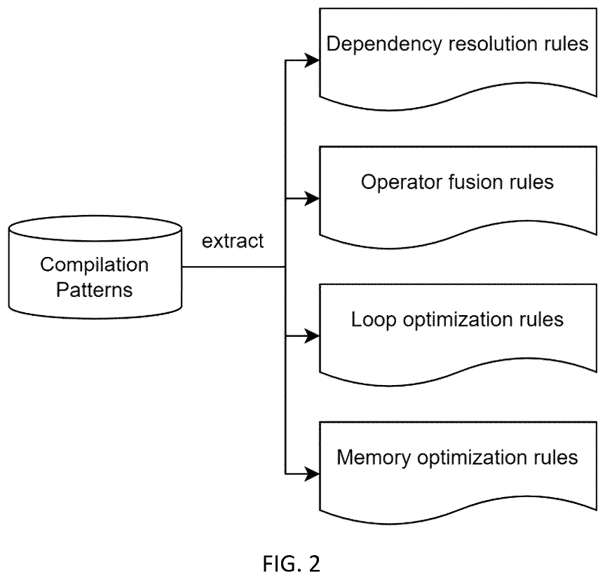

During pre-design the system generates three components: fast mapper 140, dataflow mapper 150, and toolchain builder 160. The components contain multiple rule tables and are initialized with blank rule tables. The generation is done by extracting rules from compilation patterns 120 and filling the rule tables inside each component as shown in FIG. 2.

Based on the compilation patterns, the meta compiler 130 generates rules for dependency resolution, operator fusion, loop optimization, and memory optimization. Dependency resolution rules describe the way to resolve data dependencies and operator dependencies, which are useful when allocating memory and scheduling the operators. Operator fusion rules describe the operator combinations that can be fused into one operator, which allows fused operators to be eliminated or pipelined inside the accelerator. Loop optimization rules include valid optimization techniques, such as permutation and tiling, for each operator. Memory optimization rules include rules to allocate memory space for tensors in external/internal memory.

Fast mapper 140 converts neural network (or other machine learning) models 135 to coarse-grained operator descriptions. The fast mapper uses compilation patterns 120 to transform high-level neural network operations to coarse-grained hardware operations using dependency resolution rules, and operator fusion rules. For example, a convolutional layer in a neural network may be mapped to a series of multiply-accumulate operations and memory accesses. By analyzing the dependencies between operations the fast mapper ensures that data is processed in the correct order, avoiding conflicts or stalls during execution. The fast mapper may also engage in operator fusion, combining multiple operations into a single, more efficient operation to reduce overhead and optimize performance. For example, the fast mapper may choose to fuse a convolution operation with a batch normalization step. By providing a quick and efficient mapping, the system of the present invention can later simulate and evaluate design candidates in the coarse-grained design phase. Further, the fast mapper 140 ensures that the hardware accelerator can process the neural network (or other machine learning) model in a high-level, simplified form.

Dataflow mapper 150 converts coarse-grained operator descriptions to fine-grained dataflow descriptions, and it requires compilation patterns 120 from coarse-grained operators to create fine-grained dataflow, loop optimization rules, and memory optimization rules. In particular, the dataflow mapper 150 can perform dataflow optimization by creating sequences of fine-grained dataflows that are specific to a selected hardware architecture. For example, dataflow mapper 150 can define how data is fetched from memory, processed by computation units, and stored back into memory for each operation. For loop optimization, techniques like tiling, unrolling, or permutation are applied to optimize the execution of loops (e.g., matrix multiplications) for the hardware. In general, dataflow mapper 150 ensures that computation is parallelized wherever possible, minimizing memory bottlenecks and maximizing throughput.

Further, the dataflow mapper can allocate and manage memory usage for intermediate data, ensuring efficient use of internal buffers and minimizing external memory access. By providing a fine-grained description of how the hardware accelerator should execute the neural network model, enabling detailed simulation and optimization in the fine-grained design phase.

Toolchain builder 160 generates the software tools 165 and frameworks necessary for programming, testing, and deploying each candidate hardware accelerator. It ensures that the accelerator can be used effectively with neural network and other machine learning models. The toolchain builder 160 creates a compiler that translates high-level neural network models (e.g., written in TensorFlow, PyTorch, or ONNX) into instructions executable by the hardware accelerator. The toolchain builder 160 further creates a software development kit (SDK) 165 which can provide APIs and libraries that enable users to interact with the hardware accelerator, program new models, or fine-tune its performance. The toolchain builder may also generate verification and debugging tools for testing the hardware accelerator, including test vectors 170 and runtime binaries for debugging. In this manner, the toolchain builder bridges the gap between the hardware accelerator and the user, enabling the deployment of machine learning models on the accelerator.

After the pre-design phase 110, the a coarse-grained design phase 200 of the hardware accelerator is performed. During the coarse-grained design phase 200, an architecture optimizer 210 interacts with fast mapper 140 and a coarse-grained simulator 220 and generates provisional accelerator design candidates based on various user-defined design constraints.

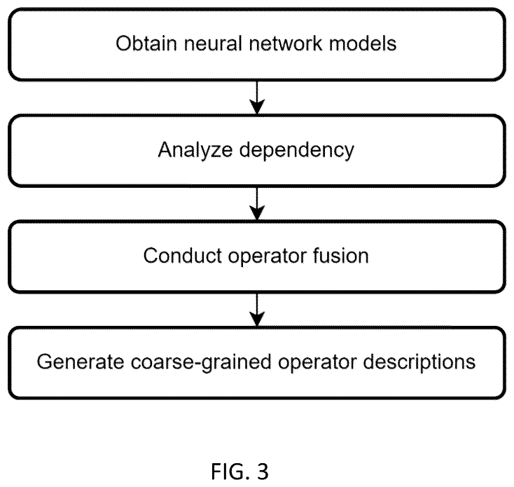

The fast mapper 140 converts neural network models to coarse-grained operator descriptions using the compilation patterns and rules obtained from the pre-design phase. A flow chart of this process is depicted in FIG. 3. The fast mapper first obtains neural network models. These models describe the architecture, configuration of operations, weight value, etc. These may use formats such as be TensorFlow, Pytorch, or ONNX. The input neural network models will be considered as optimization objectives for the hardware accelerator design. The fast mapper 140 then analyzes operator and data dependencies inside a compute graph of each neural network model and converts neural network operators to coarse-grained operators. The converted operators are then fused based on the operator fusion rules. The coarse-grained operators can be recognized by and simulated in the coarse-grained simulator.

The coarse-grained simulator 220 evaluates the performance of each hardware accelerator design candidate generated by the architecture optimizer 210. It provides approximate performance metrics for accelerator configurations by simulating how neural network operations would execute on the proposed hardware. Coarse-grained operators are obtained from the fast mapper 140, while accelerator architecture is obtained from the architecture optimizer. Metrics may include latency, chip area, power consumption, resource utilization, etc. Simulation profiles provide the information necessary to perform the simulation and may vary in different implementations, depending upon a selected machine learning model, for example.

The coarse-grained simulator 220 provides fast estimations by simplifying the simulation process. The coarse-grained simulator 220 can be implemented by an analytical model or by transaction-level simulation or a combination of both. For analytical model implementation, the metric is formulated by mathematical equations. These equations are included in the simulation profiles 250. The equations are implemented in programming languages like C or Python and transformed to programs that can be invoked by the architecture optimizer 210.

Transaction-level simulation simulates the transactions between hardware modules and is typically implemented in SystemC. The SystemC code is included in the simulation profiles. The simulation is driven by transaction events outside the hardware modules, thus the detailed implementation inside the hardware modules can be omitted. It can be used to provide latency or other intermediate metrics that can be utilized by analytical model. Both implementations are fast, which allows the architecture optimizer 210 to evaluate a greater number of design points and to explore more pareto-optimal accelerator designs.

The architecture optimizer 210 generates provisional hardware accelerator designs candidates based on the estimations obtained from the coarse-grained simulator 220. The input to the architecture optimizer 210 includes design objectives and constraints 240, and hardware accelerator templates 230. Design objectives 240 are user-defined objectives for the hardware accelerator design. For example, total power consumption during processing, average cost of chip manufacture, and average latency of all machine learning/neural network models. The design objectives can be formulated based on metric estimations from simulator. Design constraints are user-defined constraints for the hardware accelerator design. For example, maximum latency of one machine learning/neural network model, maximum chip area, and minimum operating frequency. Hardware accelerator templates 230 are parameterizable blueprints for hardware components such as compute engines or memory interfaces of hardware of accelerators. A fully functional hardware accelerator can be built by fixing all the parameters in a hardware accelerator template. The hardware modules are typically implemented in Hardware Description Language (HDL) at either Register-Transfer Level (RTL) like Verilog or High Level Synthesis (HLS) like SystemC. An example of an accelerator template is described in detail in the Examples.

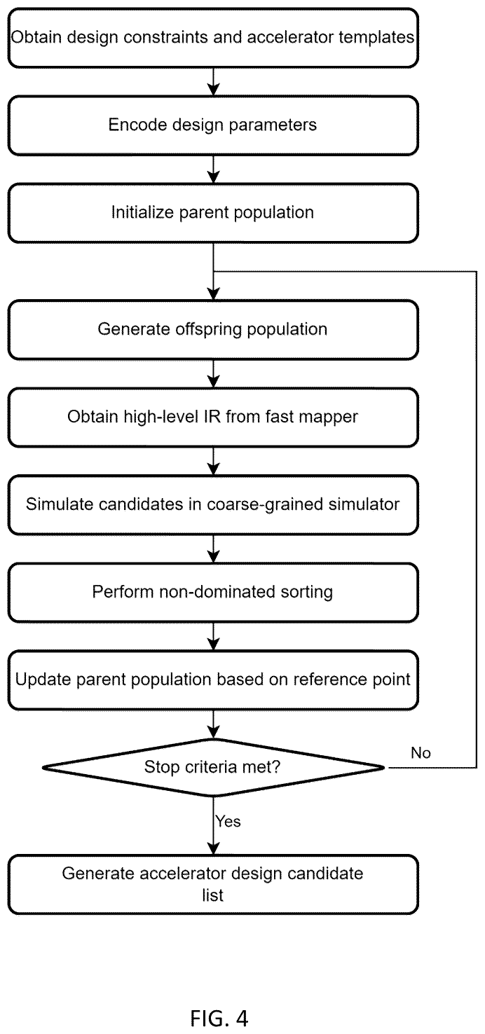

A flow chart of an example of an architecture optimizer 210 is shown in FIG. 4. A Non-dominated Sorting Genetic Algorithm (NSGA) is used in this example in order to explore the design space. This algorithm, or another selected optimization algorithm, iteratively generates, evaluates and refines provisional hardware accelerator designs based on their performance metrics. As seen in FIG. 4, design constraints and accelerator templates are obtained and encoded into design parameters.

A set of design candidates is randomly initialized and saved as a parent population. The offspring population is generated by performing crossover and mutation on the parent population. All candidates are then simulated in coarse-grained simulator 220. The obtained estimations are then used to perform non-dominated sorting. The candidates in parent population are updated based on a reference point, which is derived from the estimations. If stop criteria are not met, the architecture optimizer will go back and generate another offspring population and iterate the rest processes. The stop criteria may include reaching a specific number of iterations, obtaining a specific number of pareto optimal candidates, etc. If stop criteria are met, the architecture optimizer will generate provisional hardware accelerator design candidates in a current parent population as a provisional accelerator design candidate list. In this way, a starting point is provided for further refinement during the fine-grained design phase.

In the fine-grained design phase 300, a dataflow optimizer 320 interacts with the dataflow mapper 150 and a fine-grained simulator 310 to create a hardware accelerator design candidate list based on the provisional accelerator design candidate list.

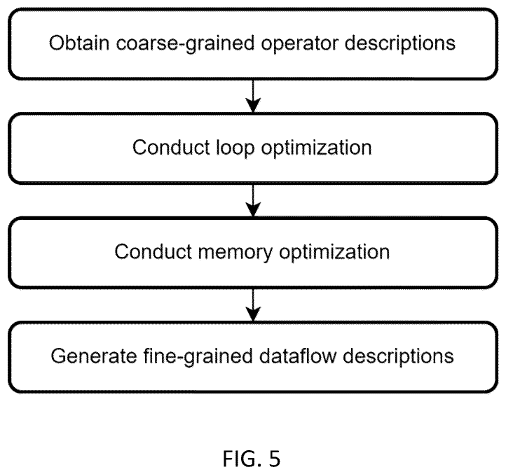

Dataflow mapper 150 converts coarse-grained operator descriptions to fine-grained dataflow descriptions, as described above. A flow chart of an example of this process is shown in FIG. 5. Coarse-grained operator descriptions are obtained from dataflow mapper 150. The dataflow optimizer 320 conducts loop optimization and memory optimization for each operator based on rules extracted by the meta compiler 130. Loop optimization techniques may include loop tiling, loop unrolling, and loop permutation. During memory optimization, dataflow mapper 150 first allocates memory space without conflict for all data in each operator, then iteratively optimizes the memory space by splitting, merging, and reallocating. The fine-grained dataflow descriptions can then be generated based on the compilation rules and conducted optimizations. The fine-grained operators can be recognized by and simulated in the fine-grained simulator 310.

Fine-grained simulator 310 simulates the fine-grained operators on a given accelerator architecture and generates metric estimations of the resulting process. Compared to the coarse-grained simulator 220, fine-grained simulator 310 provides more accurate estimations by simulating both coarse-grained architecture and fine-grained dataflow. Simulation profiles are needed to provide necessary information for fine-grained simulation according to implementations. Functional simulation in SystemC can serve as one implementation of fine-grained simulation. Detailed implementation inside the hardware modules is required for functional simulation to provide accurate estimations. Another implementation is system identification which builds mathematical models from statistical data of simulation. The statistical data can be obtained from other electronic design automation (EDA) tools and stored in the simulation profiles. System identification can provide an accurate estimation of each hardware module. By providing more accurate estimation, dataflow optimizer can optimize the fine-grained dataflow and improve the quality of results.

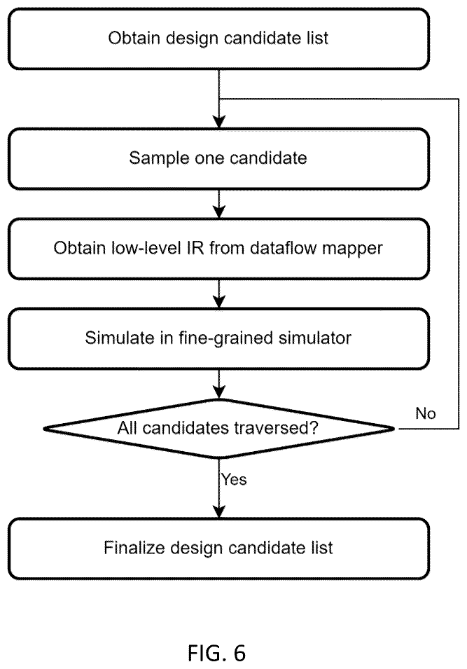

The dataflow optimizer 320 creates the accelerator design candidate list based on provisional candidate list that is obtained from coarse-grained design phase. An example dataflow optimizer flow chart is shown in FIG. 6. An exhaustive method is implemented in this example. The accelerator design candidate list is obtained from coarse-grained design phase 200. Next, the dataflow optimizer 320 samples one candidate from the candidate list. The coarse-grained operator descriptions are obtained from dataflow mapper 150 and simulated in fine-grained simulator. The metric estimations of the candidate are updated accordingly. If candidates are not fully traversed, the dataflow optimizer 320 will sample another candidate and repeat the simulation. If all candidates are traversed, the dataflow optimizer 320 will stop the iteration and create a design candidate list. During the list creation, non-dominated sorting will be conducted based on updated metric estimations. Some candidates might be removed from the candidate list during the sorting process. Only pareto-optimal design candidates will be kept in the list.

In a generation phase 400, a custom-designed and optimized hardware accelerator 500 and toolchain are generated by accelerator generator 410 for each accelerator design in candidate list. For each design in the candidate list, the accelerator generator 410 generates a tailor-made accelerator by hardcoding design parameters into the corresponding accelerator template. The accelerator generator 410 also generates hardware constraints for the toolchain builder. Hardware constraints may include maximum length of instruction, maximum depth of internal memory, etc.

Based on the hardware constraints from the accelerator generator 410 and the compilation patterns and rules from meta compiler 130, the toolchain builder 160 builds a custom toolchain, including compiler, SDK, etc. The generated toolchain is tailor-mode for corresponding accelerator, and can be used for further development, verification, deployment and other functions. For example, the toolchain can be used to generate a test vector 170, which can serve as input to the hardware accelerator 500 during verification or debugging. The toolchain can also be used to generate runtime binary 180, which contains a set of machine code that can be executed by the hardware accelerator 500 to process a neural network workload.

When plural Pareto-optimal hardware accelerator/toolchain pairs are created, further evaluation may be performed in order to select a final design for implementation.

### EXAMPLES

### 1. Architecture Optimizer

FIG. 4 shows an example of an architecture optimizer 210. A NSGA is used in this example in order to explore the design space. This algorithm, or another selected optimization algorithm (for example, Reinforcement Learning), iteratively generates, evaluates and refines provisional hardware accelerator designs based on their performance metrics. As seen in FIG. 4, design constraints and accelerator templates are obtained and encoded into design parameters. A set of design candidates is randomly initialized and saved as a parent population. The offspring population is generated by performing crossover and mutation on the parent population. All candidates are then simulated in coarse-grained simulator 220. The obtained estimations are then used to perform non-dominated sorting. The candidates in parent population are updated based on a reference point, which is derived from the estimations. If stop criteria are not met, the architecture optimizer will go back and generate another offspring population and iterate the rest processes. The stop criteria may include reaching a specific number of iterations, obtaining a specific number of pareto optimal candidates, etc. If stop criteria are met, the architecture optimizer will generate provisional hardware accelerator design candidates in a current parent population as a provisional accelerator design candidate list. In this way, a starting is provided for further refinement during the fine-grained design phase.

### 2. Example Accelerator Template

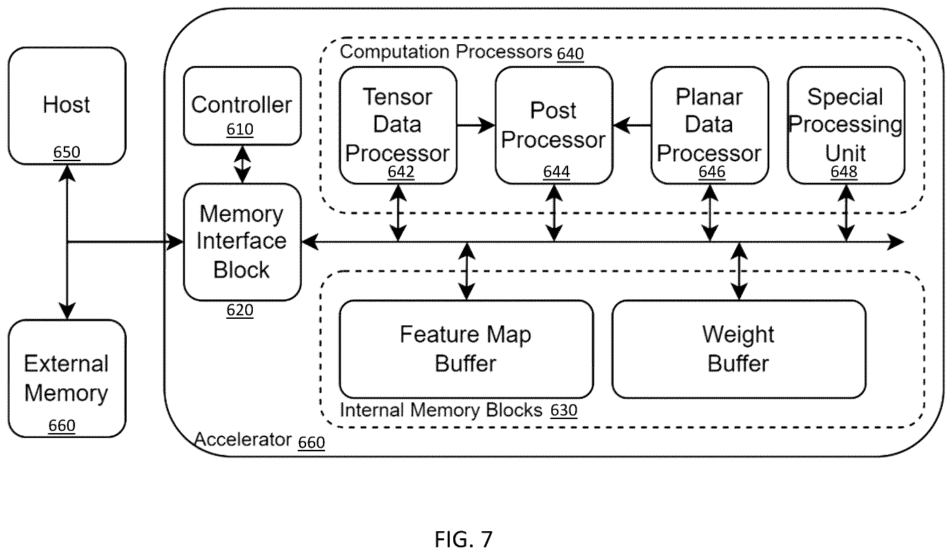

FIG. 7 schematically depicts a hardware accelerator template. The accelerator 600 of the template is composed of a controller 610, a memory interface block 620, several internal memory blocks 630, and several computation processors 640. The controller 610 loads runtime binary and controls behavior of the whole accelerator, such as communication a with host 650, communication with external memory 660, and dataflow in computation processors 640. Communication with host 650 and external memory 660 are implemented by memory interface block 620. Internal memory blocks 630 store the input, output, weight, or intermediate data of the neural networks. To fulfill the design constraints, internal memory blocks 630 may have different sizes or architectures. Computation processors 640 load data from internal memory blocks 630 and store data to internal memory blocks 630 after the computation is completed. Computation processors 640 support different operations. An operation may have different implementations. One type of computation processor may be instantiated multiple times to fulfill the parallelism requirement. Some computation processors may have direct connections in between to allow pipelined processing. Four types of computation processors are shown here: tensor data processor (TDP) 642, Post processor (PP) 644, planar data processor (PDP) 646, and special processing unit (SPU) 648. The TDP 642 and SPU 648 will be introduced in detail as examples.

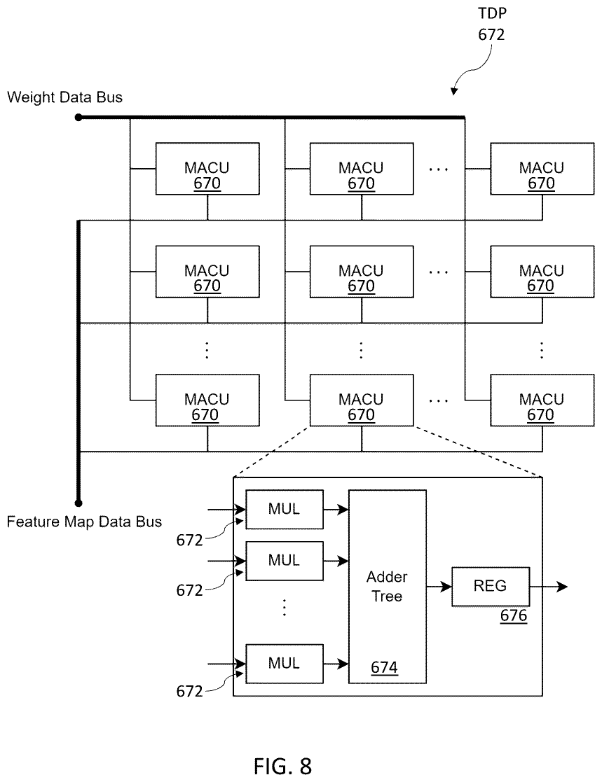

An example design of a TDP 642 is shown in FIG. 8. The TDP is designed to process convolution and matrix multiplication operations. It is composed of an array of multiply-accumulate units (MACUs) 670. Two data buses are connected to weight buffer and feature map buffer respectively. Data bus loads data from buffer to MACUs. To maximize data reuse, MACUs in the same row share the same feature map data, MACUs in the same column share the same weight data. Each MACU has a vector of multiplier 672, an adder tree 674, and a register 676. Weight data and feature map data are first multiplied by multipliers and then accumulated in the adder tree. The register stores the partial sum result, which allows MACU to be configured in output-stationary dataflow. Weight-stationary and feature-stationary dataflow are also supported. Configurable parameters include the size of MACU array, number of multipliers, depth of adder tree, etc. By adjusting these parameters, TDP 642 can be configured to fulfill a wide range of requirements on throughput, timing, area, etc.

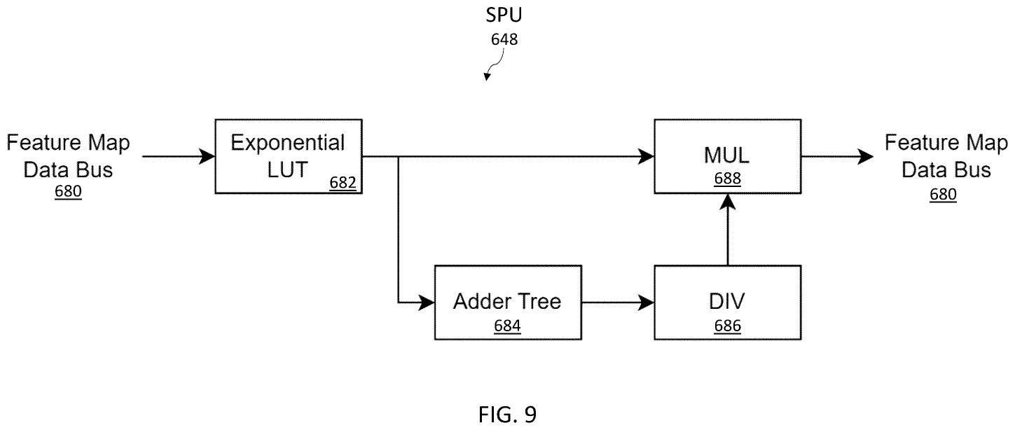

Another example is SPU as shown in FIG. 9. This example SPU 648 is designed for softmax operation. It first loads a batch of feature map data from the data bus 680. Then obtains exponent of each data by an exponential Look Up Table (LUT) 682. The coefficient is computed by accumulating exponent values in adder tree 684 and inverting in the divider 686. After multiplying exponents and coefficient in multiplier 688, the output data is stored back to feature map buffer. The trade-off between area and performance can be made by adjusting the number of parallel exponential LUTs and multiplier, bit-width of exponential LUT, etc.

### 3. Evaluation Results

Illustrated below are some evaluation results demonstrating the effectiveness of this system. The target networks are EfficientViT, SegFormer, and Swin-Transformer variation (noted as SwinT-Like). The target accelerator architecture is same as introduced example accelerator template. In this template, TDP, PDP, PP, SPU have 4, 3, 1, 2 configurable parameters respectively. TDP, PDP, and PP are instantiated twice to build a dual-engine-style accelerator. The whole design space can reach 5556320 design points. The design optimization objectives are latency, throughput, power efficiency, area, and accuracy.

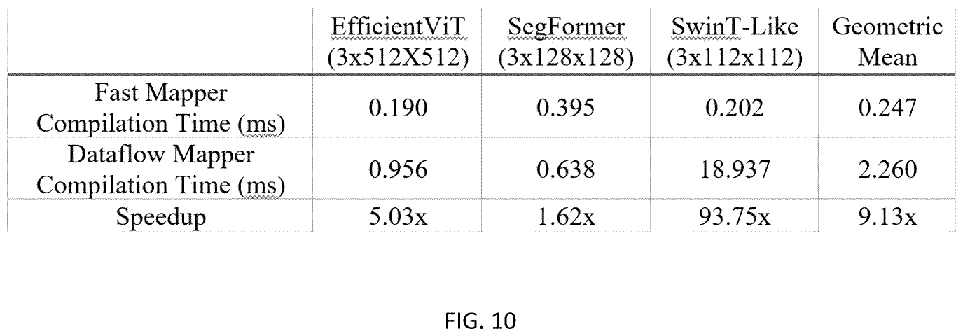

In FIG. 10, the compilation time between fast mapper and dataflow mapper is compared. As introduced, coarse-grained design phase conducts fast metric estimations, which requires fast conversion from neural network models to coarse-grained operator descriptions. On the other hand, dataflow mapper requires fine-grained dataflow mapping, thus is more time-consuming than fast mapper. The results show that fast mapper can provide faster mapping than dataflow mapper in all evaluated models. The compilation time can be reduced by 11.10× on the geometric mean.

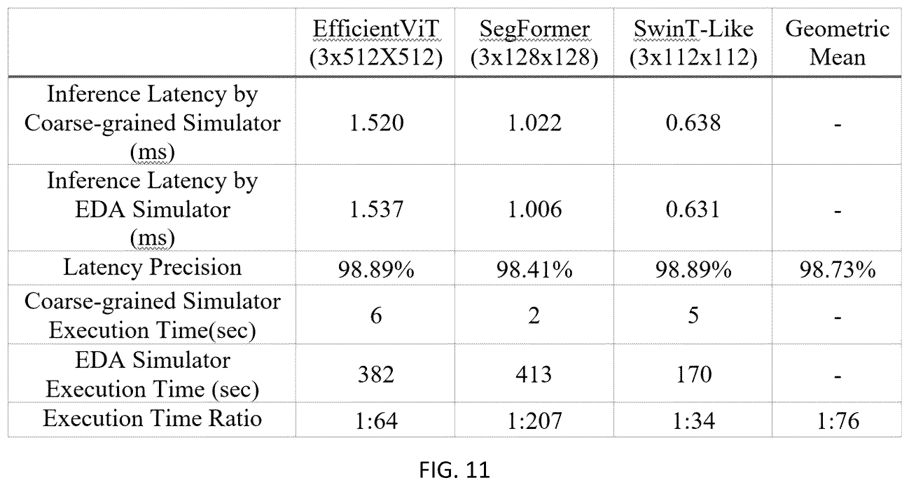

In FIG. 11, the precision and speed of coarse-grained simulator is compared to conventional EDA simulator (Cadence Xcelium Logic Simulator). Precision and speed of simulator are crucial in the optimization loop. Precision can affect the quality of results while speed can affect the size of the explored design space. The results demonstrate that coarse-grained simulator is 76× faster than the EDA simulator while maintaining 98.73% precision on geometric mean.

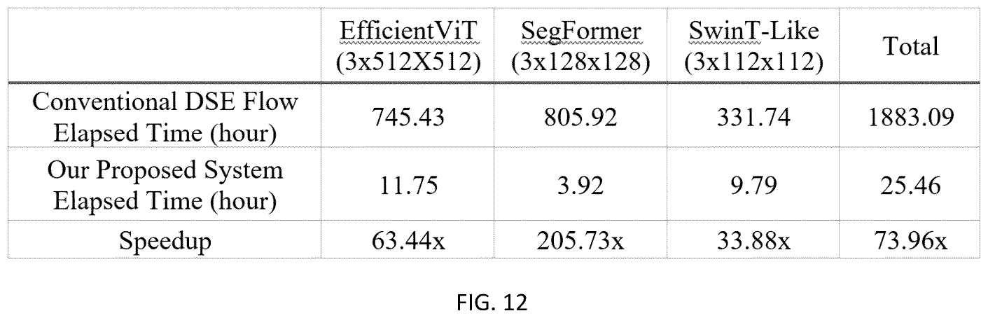

In FIG. 12, the elapsed time of conventional design space optimization flow is compared with the system of the present invention to finish an end-to-end design optimization. The maximum sample number is 7000 for both conventional flow and the system of the present invention. Both evaluations are run on the same workstation. The results show that conventional design space optimization flow requires 1883.09 hours (78.46 days) to finish. On the other hand, the present system only needs 25.46 hours to finish the design optimization at the same size. Conventional design space optimization flow requires more time to evaluate the design points since it does not support multi-granularity mappers and simulators. With the present system, the efficiency of the design space optimization can be improved by 73.96×. Accordingly, with the significant improvement in the design space optimization efficiency, the computational speed for the operation is significantly increased with a reduced compute power consumption and dissipation during this operation.

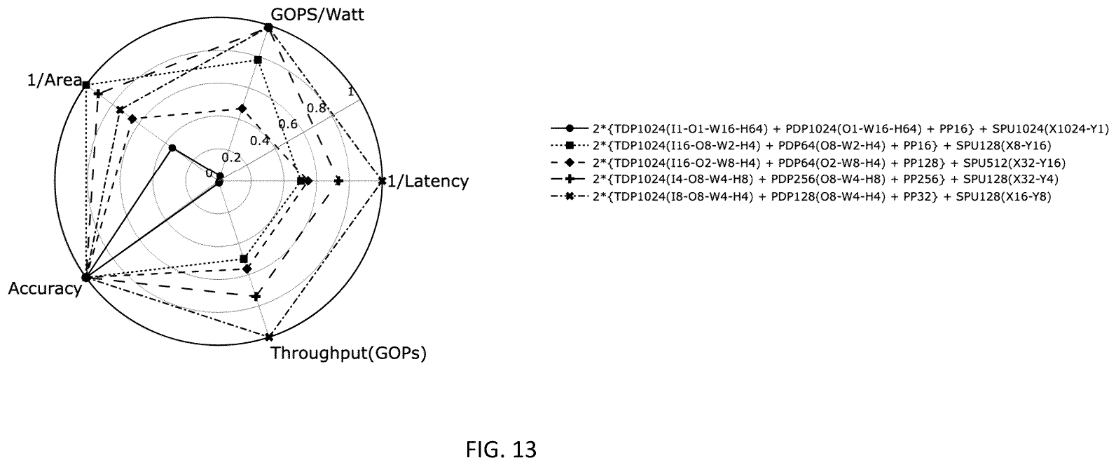

In FIG. 13, the radar chart compares the objective value of 5 accelerator designs that are sampled from the design space. For better visualization, latency and area are converted to their inversion, so all metrics in the radar chart are maximum objectives, i.e., the larger the better. Also, all metrics are normalized to their maximum value. Start from innermost, the design in yellow (the inner-most design) is the worst design, it underperforms in all metrics. All other designs can beat this design. The blue design in the middle (the middle design) is sampled from the intermediate results.

This design is dropped in later optimization due to better designs being explored. The outermost 3 designs in green, purple, and orange are pareto optimal designs, which are part of the system output. Due to the space limitation, not all pareto optimal designs are shown in the radar chart. Among these three designs, one of the designs (the green design) outperforms in latency, throughput, and energy efficiency at a cost of ˜2× area. The smallest-area design (the purple design) has the smallest area but is defeated in all other objectives. The last one of the three designs (the orange design) is a moderate design, i.e., all objectives are not the worst. These three designs can also be considered as different design goals: performance-optimized, area-optimized, and balanced. The results demonstrate that different configurations can lead to significant performance gaps, even between pareto optimal designs, e.g., 1.75× throughput improvements from area-optimized design to performance-optimized design. The present system can capture the trade-off in accelerator design and generate multiple pareto optimal designs in different design goals simultaneously. This allows the user to compare and shift between different designs without rerunning the whole optimization, which significantly improves the accelerator design efficiency.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

It should be understood that numerous specific details, relationships, and methods are set forth to provide a full understanding of the invention. One having ordinary skill in the relevant art, however, will readily recognize that the invention can be practiced without one or more of the specific details or practiced with other methods and protocols. The present invention is not limited by the illustrated ordering of acts or events, as some acts may occur in different orders and/or concurrently with other acts or events. Furthermore, not all illustrated acts, steps or events are required to implement a methodology in accordance with the present invention. Many of the techniques and procedures described, or referenced herein, are well understood and commonly employed using conventional methodology by those skilled in the art.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

1. A method for designing and optimizing hardware accelerators for neural networks comprising:
extracting rules from compilation patterns in a pre-design phase in which the compilation patterns describe conversion between neural network operators, coarse-grained operators, and fine-grained dataflow;
generating a fast mapper for converting neural network models to coarse-grained operator descriptions, a dataflow mapper converting the coarse-grained operator descriptions to fine-grained dataflow, loop optimization rules, and memory optimization rules, and a toolchain builder;
performing a coarse-grained design phase, employing an architecture optimizer to interact with the fast mapper to generate plural provisional hardware accelerator designs balancing one or more of power consumption optimization, latency optimization, chip area, and throughput and simulating coarse-grained operator descriptions on each provisional accelerator design using a coarse-grained simulator to obtain performance metrics of each provisional accelerator design;
performing a fine-grained design phase with a dataflow mapper and fine-grained simulator to produce one or more selected hardware accelerator designs from the plural provisional accelerator designs and generating fine-grained dataflow descriptions based on compilation rules and conducted optimizations;
generating, in a generation phase, one or more hardware accelerators from the produced hardware accelerator designs and creating a corresponding software toolchain for each produced hardware accelerator design, the software toolchain including a compiler and software development kit (SDK) for programming, debugging, and deploying each produced hardware accelerator design.

2. The method of claim 1, wherein the compilation patterns include rules for one or more of:
dependency resolution, operator fusion, loop optimization techniques, or memory optimization for allocating internal and external memory without conflicts.

3. The method of claim 1, wherein the coarse-grained simulator uses transaction-level simulation or analytical models to estimate performance metrics, including latency, throughput, power consumption, and chip area.

4. The method of claim 1, wherein the fine-grained simulator simulates detailed hardware module operations using functional simulation or system identification techniques.

5. The method of claim 1, wherein generating the hardware accelerator comprises hardcoding the parameter values of the accelerator template to create computation processors, memory modules, and dataflow architectures and adjusting configurable parameters, selected from one or more of the size of computation arrays, buffer depth, and internal memory, to meet the design objectives.

6. The method of claim 1, wherein generating the software toolchain comprises:
creating runtime binaries to execute neural network models on the hardware accelerator;
generating test vectors for validation and debugging of the hardware accelerator; and
producing application programming interfaces (APIs) to facilitate user programming of the accelerator.

7. The method of claim 1, further comprising:
generating one or more Pareto-optimal hardware accelerator design by applying an optimization algorithm on performance metrics obtained from the coarse-grained simulator.

8. The method of claim 1, wherein the produced hardware accelerators and software toolchains are tailored for one or more specific neural network models.

9. The method of claim 1, wherein specific neural network model is a convolutional neural network, a deconvolutional neural network, a recurrent neural network, a feed-forward neural network, a generative adversarial network, a Transformer-based architecture, a Mamba-based state space model, or a mixture of experts (MoE) architecture.

10. A system for automating the design and implementation of neural network accelerators and corresponding toolchains, comprising:
a meta compiler configured to extract dependency resolution rules, operator fusion rules, loop optimization rules, and memory optimization rules from input compilation patterns and generate a fast mapper, a dataflow mapper, and a toolchain builder to guide the design of the hardware accelerator;
a coarse-grained optimization module, receiving the output of the metal compiler that simulates neural network operations using coarse-grained simulation techniques to generate preliminary hardware accelerator design candidates and evaluates the design candidates against user-defined constraints, including one or more of power consumption, latency, and chip area;
a fine-grained optimization module for refining the preliminary hardware accelerator design candidates using fine-grained simulation techniques to optimize dataflows and memory utilization within the preliminary hardware accelerator design candidates to create one or more hardware accelerator design candidates;
a toolchain builder, that generates a corresponding toolchain for each final hardware accelerator design candidate, the toolchain including:
a compiler for converting neural network models into executable instructions for each hardware accelerator design candidate;
a software development kit (SDK) for further development, testing, and deployment of each hardware accelerator design candidate.

11. The system of claim 10, wherein the hardware accelerator is implemented as an application-specific integrated circuit (ASIC), a field-programmable gate array (FPGA), or a neural processing unit (NPU).
